(19) United States
(12) Patent Application Publication
(10) Pub. No.: US 2019/0034361 A1
(43) Pub. Date: Jan. 31, 2019

(54) PERIPHERAL DEVICE CONTROLLING METHOD BY USING STORAGE DEVICE AND STORAGE DEVICE CAPABLE OF CONTROLLING PERIPHERAL DEVICES

(71) Applicants: ACTION STAR TECHNOLOGY CO., LTD., New Taipei City (TW); Action Star (U.S.A.) Inc., Chino, CA (US)

(72) Inventor: CHING-WEI CHENG, New Taipei City (TW)

(21) Appl. No.: 15/662,284

(22) Filed: Jul. 28, 2017

(51) Int. Cl. G06F 13/10; G06F 17/30

(52) U.S. Cl. CPC G06F 13/102; G06F 2213/0042; G06F 2213/3806; G06F 17/30218

(57) ABSTRACT

The present invention mainly discloses a storage device capable of controlling peripheral devices, which comprises a micro processing unit, a communication unit and a storage unit. Particularly, the storage unit is separated into a plurality of storage blocks and one file table block based on a file system, and parts of the storage blocks storing with device accessing files are further set to be a peripheral device controlling block. After connecting the storage device to a peripheral device and a host electronic device, the host electronic device can control the peripheral device through changing contents of the device accessing files. Thus, for the peripheral device manufactures, it just needs to develop driver software of this storage device and an application program for accessing the device accessing file, but does not need to develop corresponding peripheral device driver softwares compatible with various host operating systems, such as Windows and iOS.

### BACKGROUND OF THE INVENTION

### 1. Field of the Invention

The present invention relates to the technology field of electronic peripheral devices, and more particularly to a peripheral device controlling method by using storage device and a storage device capable of controlling peripheral devices.

### 2. Description of the Prior Art

Along with the continuous advance of electronic sciences and technologies, there are many demands made by end-users on additional functions of computers and electronic products; accordingly, a variety of peripheral devices are hence designed, developed and produced, such as electronic writing board, printer, electronic label printing machine, loudspeaker, USB hard disk drive, USB flash drive, game joystick, USB optical disc drive, USB wireless adapter, and digital camera. FIG. 1 shows a stereo diagram of a personal computer, wherein the personal computer equipped with several types of I/O interfaces for communicating with different peripheral devices. In the early days, Firewire (IEEE 1934), EIA-RS-232 (RS232), parallel port, and Ethernet port (RJ45) were indispensable I/O interfaces for personal computers. However, with the advancement and development of sciences and technologies of portable electronic devices, nowadays, communication interfaces having plug- and play (PNP) function become the most important I/O interfaces that must be equipped to the personal computers, like PATA interface, SATA interface, ISA interface, and USB interface.

Nowadays, desk computers or notebooks can easily expand additional functions by being equipped with peripheral devices through their USB interfaces. As engineers skilled in USB device developing and producing technology field know, a specific operating system installed in a host electronic device would automatically treat an USB device with an USB enumeration procedure when the USB device is connected to the host electronic device. Taking Windows XP as the example, after the USB device is connected to the host electronic device, Windows XP executes the said USB enumeration procedure comprising following steps:
step (1′): initialing the USB device, and then setting a device address of the USB device as 0;
step (2′): requesting the USB device to reply a device descriptor with 64 bytes length;
step (3′): resetting the USB device, and then sending a “Set Address” command to the USB device so as to complete the address setting of the USB device;
step (4′): requesting the USB device to reply a device descriptor with 18 bytes length for obtaining foundational information of the USB device, at least including VID (vender identification) and PID (product identification);
step (5′): requesting the USB device to reply a configuration descriptor with 9 bytes length for getting the number of interfaces of the USB device (bNumInterfaces);
step (6′): requesting the USB device to reply an interface descriptor, so as to know the number of end points of the USB device (bNumEndpoints);
step (7′): requesting the USB device to reply an endpoint descriptor for obtaining the data transmission mode of the endpoints (bmAttributes); and
step (8′): waiting for completing the installation of corresponding driver software of the USB device. (if necessary, user needs to download the driver software and then finish the installation of the driver software by himself.)

The engineers skilled in USB device developing and producing technology field should know that, some of commercial USB devices can only support certain operating system like Microsoft Windows because the steps of the USB enumeration procedure adopted by other operating systems are not fully identical to the above-listed steps (1′)-(8′). On the other hand, USB device manufacturers usually only develop driver softwares for the USB devices they provided compatible with Microsoft Windows, but not simultaneously develop other driver softwares for making the USB devices able to support other operating systems, such as iOS, Mac OS X, Android, and Linux. In view of that, how to make USB devices be compatible with all types of operating systems becomes the most important issue for the USB device manufacturers.

FIG. 2 shows a framework view of an USB peripheral device disclosed by U.S. Pat. No. 7,921,244. The USB peripheral device 1′ proposed by U.S. Pat. No. 7,921,244 can support any types of operating systems, and comprises: a microprocessor 11′, a first USB unit 12′, a second USB unit 13′, and a storage unit 14′. In which, the first USB unit 12′ is used for connecting a first USB interface 21′ of a first host 2′, and the second USB unit 13′ is used for connecting a second USB interface 31′ of a second host 3′. By such arrangement, a first CPU 22′ in the first host 2′ is able to access data stored in the storage unit 14′ through a first I/O channel between the first USB interface 21′ and the first USB unit 12′. Similarly, a second CPU 32′ in the second host 3′ is able to access data stored in the storage unit 14′ through a second I/O channel between the second USB interface 31′ and the second USB unit 13′.

Particularly, the storage unit 14′ of the USB peripheral device 1′ has stored with a plurality of driver softwares, and the microprocessor 11′ is embedded with an automation installing application. By such arrangement, after the USB enumeration procedure is completed, the microprocessor 11′ would subsequently find corresponding driver software from the storage unit 14′ and then automatically installing the driver software in the operating system of the first host 2′ or the second host 3′. It is worth explaining that, the driver software found by the microprocessor 11′ is stored in a first storage device 23′ of the first host 2′ or a second storage device 33′ of the first host 3′ before the installation of the driver software.

After fully understanding the technology features of the USB peripheral device 1′, engineers skilled in USB device developing and producing technology field should find that the proposed technology of the USB peripheral device 1′ would exhibit several drawbacks in practice:
(1) Since the several driver softwares occupy too much storage space, the right of use of an end user purchasing the USB peripheral device 1′ is certainly damaged. For instance, the storage space of the USB peripheral device 1′ is theoretically 4 GB, but the USB peripheral device 1′ possessed by the end user maybe perform 3.5 GB storage space in reality.
(2) On the other hand, if the USB peripheral device 1′ also includes a non-USB unit like RS-232 interface or SATA interface, the end user must download and install corresponding driver software in his personal computer after the USB peripheral device 1′ is connected to the computer through the said non-USB unit. Moreover, what can be realized is that, it is impossible for the USB device manufacturers to pre-store a variety of corresponding driver softwares of the USB peripheral devices 1′ with different non-USB units in the storage unit 14′.

For above reasons, the inventors of the present application have made great efforts to make inventive research thereon and eventually provided a peripheral device controlling method by using storage device and a storage device capable of controlling peripheral devices.

### SUMMARY OF THE INVENTION

The primary objective of the present invention is to provide a peripheral device controlling method by using storage device and a storage device capable of controlling peripheral devices. Wherein the storage device capable of controlling peripheral devices can be a flash drive or other storage devices, and comprises: a micro processing unit, a first communication unit and a storage unit. In the present invention, the storage unit of the storage device is separated into a plurality of storage blocks and at least one file table block based on a file system, and one of the storage blocks storing with device accessing files is further set to be at least one peripheral device controlling block. Therefore, after connecting the storage device to a peripheral device and a host electronic device, the host electronic device can easily control the peripheral device through changing or editing contents of the device accessing files. Thus, for the peripheral device manufactures, it merely needs to develop driver software of this storage device and an application program for accessing the device accessing file, but does not need to develop corresponding peripheral device driver softwares compatible with various host operating systems, such as Windows iOS, Mac OS X, Android, and Linux.

In order to achieve the primary objective of the present invention, the inventor of the present invention provides an embodiment for the peripheral device controlling method by using storage device, comprising following steps:
(1) connecting a storage device to a peripheral device, wherein the peripheral device directly connect to a host electronic device or communicate with the host electronic device through the storage device; moreover, a storage unit of the storage device is separated into a plurality of storage blocks and one file table block based on a file system, and an operating system of the host electronic device being installed with an application program of accessing device file;
(2) accessing at least one file table from the file table block, and then finding out the storage blocks storing with at least one device accessing file through the file table;
(3) setting the storage blocks storing with the device accessing file as a peripheral device controlling block; and
(4) by changing or editing contents of the device accessing file, the peripheral device executing actions according to the controlling of the host electronic device.

Moreover, for achieving the primary objective of the present invention, the inventor of the present invention further provides one embodiment for the storage device capable of controlling peripheral devices, comprising:
a microprocessor unit;
a communication unit, being coupled to the microprocessor unit and used for connecting to a first communication interface of a peripheral device; wherein the peripheral device connecting to a host electronic device by a second communication interface thereof; and
a storage unit, being separated into a plurality of storage blocks and one file table block based on a file system, wherein the storage blocks storing with at least one device accessing files is further set as a peripheral device controlling block, and the file table block storing with at least one file table;
wherein by finding the peripheral device controlling block through the file table and subsequently changing or editing contents of the device accessing file, the peripheral device executing actions according to the controlling of the host electronic device.

Furthermore, in order to achieve the primary objective of the present invention, the inventor of the present invention further provides another one embodiment for the storage device capable of controlling peripheral devices, comprising:
a microprocessor unit;
a first communication unit, being coupled to the microprocessor unit and used for connecting to a communication interface of a peripheral device;
a second communication unit, being coupled to the microprocessor unit and used for connecting to an I/O interface of a host electronic device; and
a storage unit, being separated into a plurality of storage blocks and one file table block based on a file system, wherein the storage blocks storing with at least one device accessing files is further set as a peripheral device controlling block, and the file table block storing with at least one file table;
wherein by finding the peripheral device controlling block trough the file table and subsequently changing or editing contents of the device accessing file, the peripheral device executing actions according to the controlling of the host electronic device.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo diagram of a personal computer;

FIG. 2 shows a framework view of an USB peripheral device disclosed by U.S. Pat. No. 7,921,244;

FIG. 3 shows a framework view of a FAT file system;

FIG. 4 shows a framework view of an ext file system;

FIG. 5 shows a flowchart diagram of a peripheral device controlling method according to the present invention;

FIG. 6 shows a first stereo diagram of a first embodiment of a storage device capable of controlling peripheral devices according to the present invention;

FIG. 7 shows a framework view of the storage device capable of controlling peripheral devices;

FIG. 8 shows a second stereo diagram of the storage device capable of controlling peripheral devices;

FIG. 9 shows a third stereo diagram of the storage device capable of controlling peripheral devices;

FIG. 10 shows a stereo diagram of a second embodiment of the storage device capable of controlling peripheral devices according to the present invention;

FIG. 11 shows a framework view of the storage device capable of controlling peripheral devices.

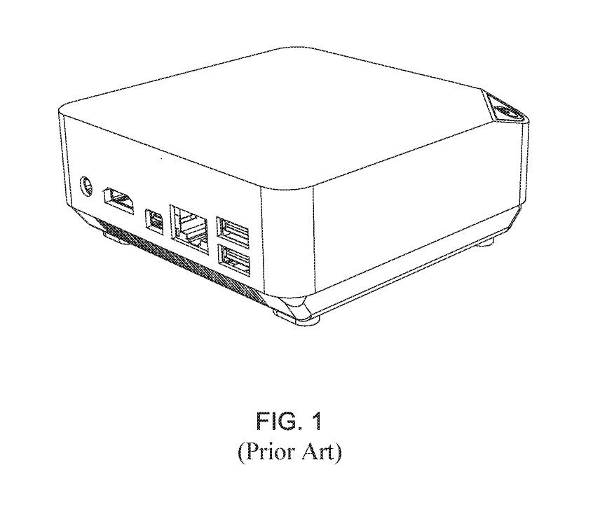

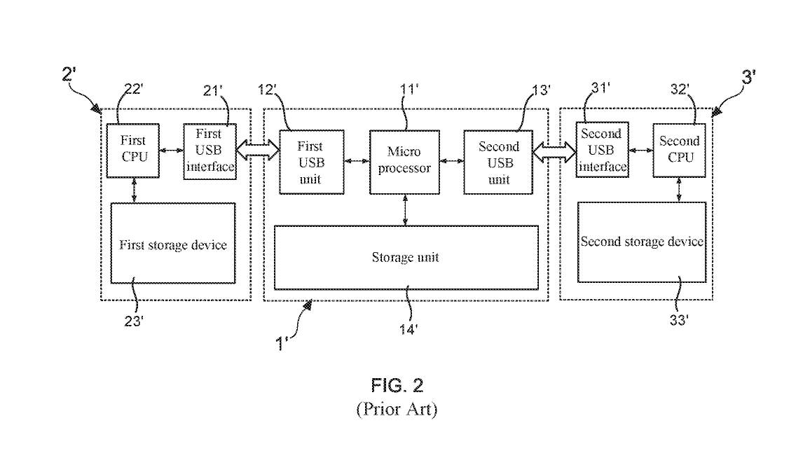

### DETAILED DESCRIPTION OF THE PREFERRED EMBODIMENTS

To more clearly describe a peripheral device controlling method by using storage device and a storage device capable of controlling peripheral devices according to the present invention, embodiments of the present invention will be described in detail with reference to the attached drawings hereinafter.

Before starting to introduce the peripheral device controlling method by using storage device of the present invention, it needs to firstly explain what is file system. File system is applied in a storage device for systematically organizing and arranging data stored in storage units or modules of the storage device. For instance, file allocation table, also abbreviated to FAT, is one type of file system developed by Microsoft. Moreover, as hard disk and flash drives evolved, the capabilities of the file system have been extended accordingly, resulting in several FAT variants, including FAT12, FAT16, FAT32, and exFAT(FAT64). It is worth mentioning that, extended file system (ext) was implemented in April 1992 as the first file system created specifically for the Linux kernel. Of course, there are still many types of file systems differing from FAT and ext being developed, such as HTFS and HFS+.

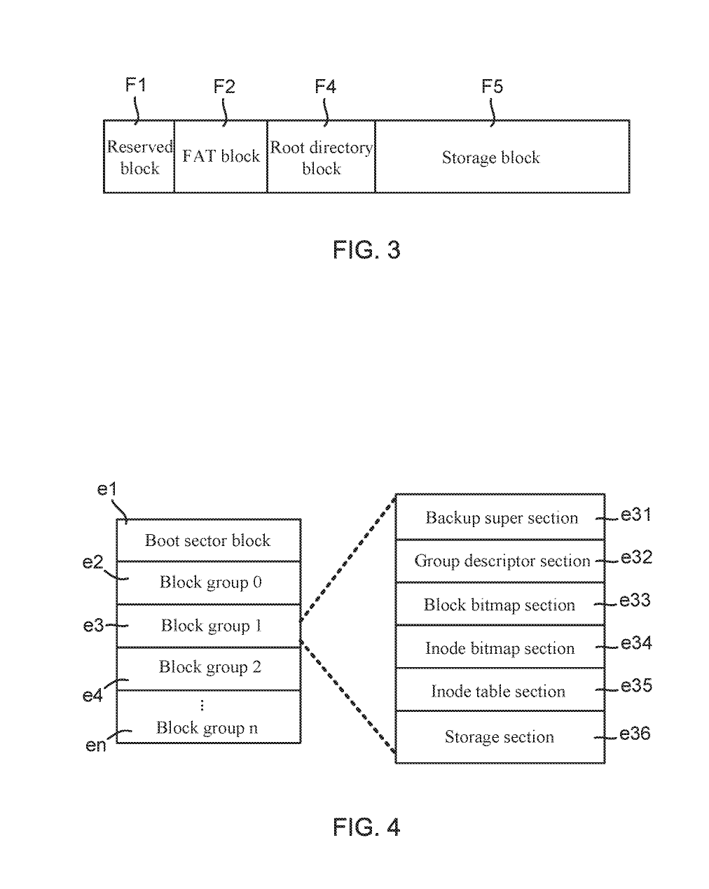

FIG. 3 shows a framework view of a FAT file system. FAT file system is applied in a storage device, and separates a storage unit of the storage device into a reserved block F1, a FAT block F2, a root directory block F4, and a storage block F5. On the other hand, according to a framework view of an ext file system presented by FIG. 4, it is able to know the ext file system separates a storage unit of a storage device into a boot sector block e1 and a plurality of group blocks, wherein the block groups comprising group block 0 e2, group block 1 e3, group block 2 e4, . . . , and group block n en. Moreover, each of the group block s, e.g., the group block 1 e3, are further divided into several sections consisting of a backup super section e31, a group descriptor section e32, a block bitmap section e33, an Inode bitmap section e34, an Inode table section e35, and a storage section e36.

After comparing FIG. 3 with FIG. 4, it can find that, both FAT and ext file systems arrange file allocation tables in storage device. For the FAT file system, the said file allocation tables presented by the FAT block F2 and the root directory block F4. However, ext file system separates the file allocation tables into the group descriptor section e32, the block bitmap section e33, the Inode bitmap section e34, and the Inode table section e35.

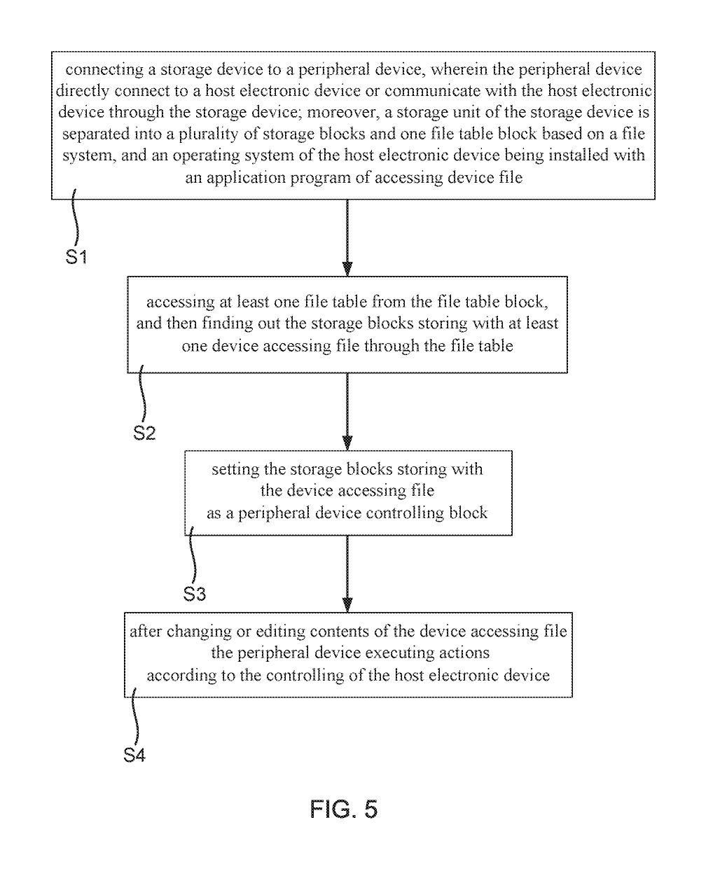

Based on the knowledge of the file systems and the experience on development and manufacture of USB devices, inventors of the present invention propose a new technology for making a host computer able to control its peripheral devices through a file system applied in a storage device. Please refer to FIG. 5, which illustrates a flowchart diagram of a peripheral device controlling method according to the present invention. As FIG. 5 shows, the peripheral device controlling method of the present invention comprises following steps:
Step (1): connecting a storage device to a peripheral device, wherein the peripheral device directly connect to a host electronic device or communicate with the host electronic device through the storage device; moreover, a storage unit of the storage device is separated into a plurality of storage blocks and one file table block based on a file system, and an operating system of the host electronic device being installed with an application program of accessing device file;
Step (2): accessing at least one file table from the file table block, and then finding out the storage blocks storing with at least one device accessing file through the file table;
Step (3): setting the storage blocks storing with the device accessing file as a peripheral device controlling block; and
Step (4): after changing or editing contents of the device accessing file, the peripheral device executing actions according to the controlling of the host electronic device.

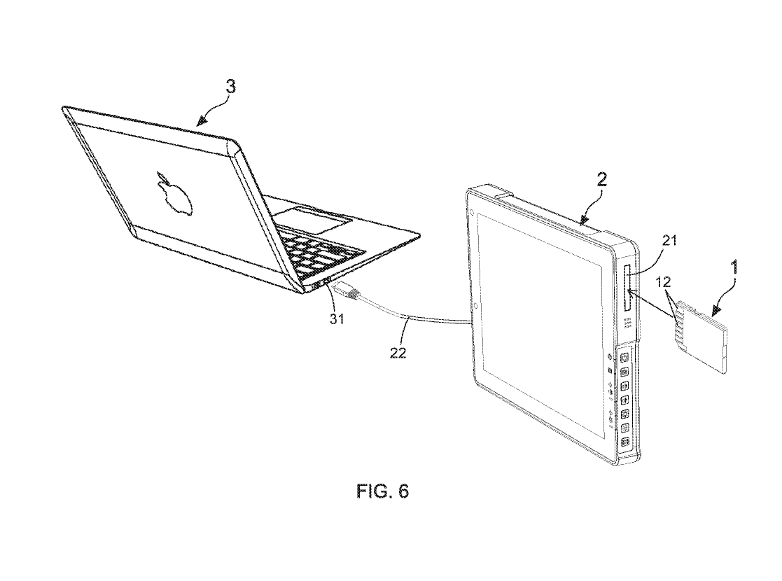

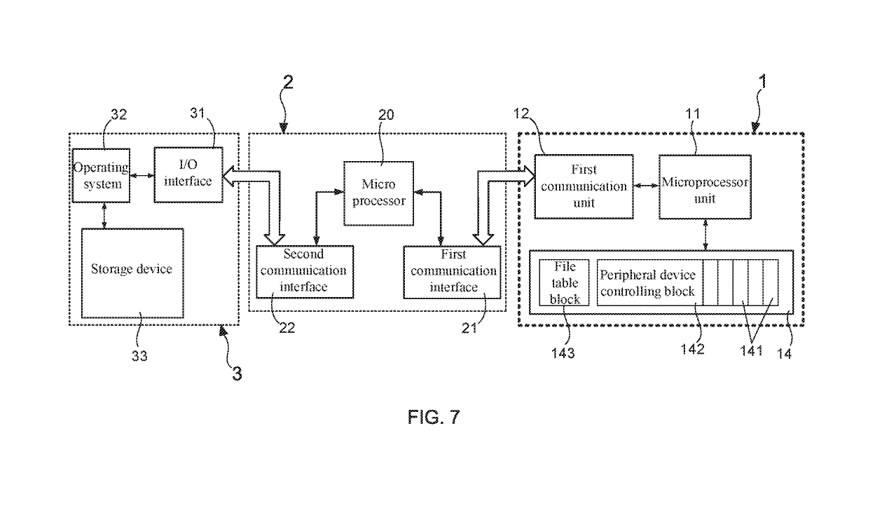

For facilitating engineers skilled in USB device developing and producing technology field able to understand this peripheral device controlling method more easily, in following paragraphs, stereo and framework diagrams of a storage device capable of controlling peripheral devices will be provided for auxiliarily explaining the peripheral device controlling method. FIG. 6 shows a first stereo diagram of a first embodiment of a storage device capable of controlling peripheral devices according to the present invention, and FIG. 7 presents a framework view of the storage device capable of controlling peripheral devices. In first embodiment, the said storage device 1 is a memory card and inserted into a card slot 21 of a digital photo frame, which is a peripheral device 2 of a host electronic device 3. As FIG. 6 shows, the storage device 1 has only one communication interface such as a card-edge board connector.

Particularly, the storage device 1 is also used for storing a plurality of setting parameters of the digital photo frame (peripheral device 2). According to FIG. 6 and FIG. 7, it is able to know that the storage device 1 comprises a microprocessor unit 11, a first communication unit 12 (i.e., the card-edge board connector) and a storage unit 14, wherein the first communication unit 12 is coupled to the microprocessor unit 11 and used for connecting to a first communication interface 21 (i.e., the card slot) of the peripheral device 2. On the other hand, the peripheral device 2 is connected to the host electronic device 3 by a second communication interface 22 thereof.

In the present invention, the storage unit 14 is separated into a plurality of storage blocks 141 and one file table block 143 based on a file system, wherein the storage blocks 141 storing with at least one device accessing files is further set as a peripheral device controlling block 142. In addition, the file table block 143 is also constituted by at least one storage block 141 for storing with at least one file table. After comparing FIG. 7 with FIG. 3 and FIG. 4, engineers skilled in storage device developing and manufacturing technology field should understand that, the said file table block 143 can be equal to the combination of FAT block F2 and the root directory block F4 or the combination of the group descriptor section e32, the block bitmap section e33, the Inode bitmap section e34, and the Inode table section e35. Briefly speaking, the practice model of the file table block 143 varies with different types of the file systems, such as FAT, FATE, FAT12, FAT16, FAT32, exFAT, ISO9660, UDF, NTFS, HFS, HFS+, ext2, ext3, and ext4.

Moreover, because at least one storage block 141 is further set as a peripheral device controlling block 142 for storing at least one device accessing files, the host electronic device 3 is able to control the peripheral device 2 to execute actions after finding the peripheral device controlling block 142 through the file table and subsequently changing or editing contents of the device accessing file. Herein, the said host electronic device 3 does not limited to be a laptop computer, but can also be a portable electronic device, a server device, a smart phone, a tablet PC, a smart watch, a desk computer, or an industrial computer.

To more clearly explain how the host electronic device 3 controls the peripheral device 2. After a communication channel is established between an (USB) I/O interface 31 of the host electronic device 3 and the second (USB) communication interface 22 of the peripheral device 2, the device accessing file of “monitor.xml” can be easily found out from the storage device 1. Next, the storage block 141 storing with the device accessing file of “monitor.xml” would be set as a peripheral device controlling block by an operating system 32 of the host electronic device 3 and its file system. Thus, by using a text editor program installed in the operating system of the host electronic device 3, it is able to change or edit a plurality setting parameters of the digital photo frame (peripheral device 2), like brightness and contrast. Moreover, after the setting parameters written in the “monitor.xml” are changed, microprocessor 20 immediately executes corresponding setting or adjusting to brightness and contrast of the digital photo frame (peripheral device 2). On the other hand, an image and video studio program can also be simultaneously installed in the operating system of the host electronic device 3, and used for accessing image and video files stored in the digital photo frame (peripheral device 2). Of course, through the image and video studio program, some local image and video files stored in at least one storage device 33 of the host electronic device 3 can be transmitted to the digital photo frame, so as to display these local images or videos by the digital photo frame.

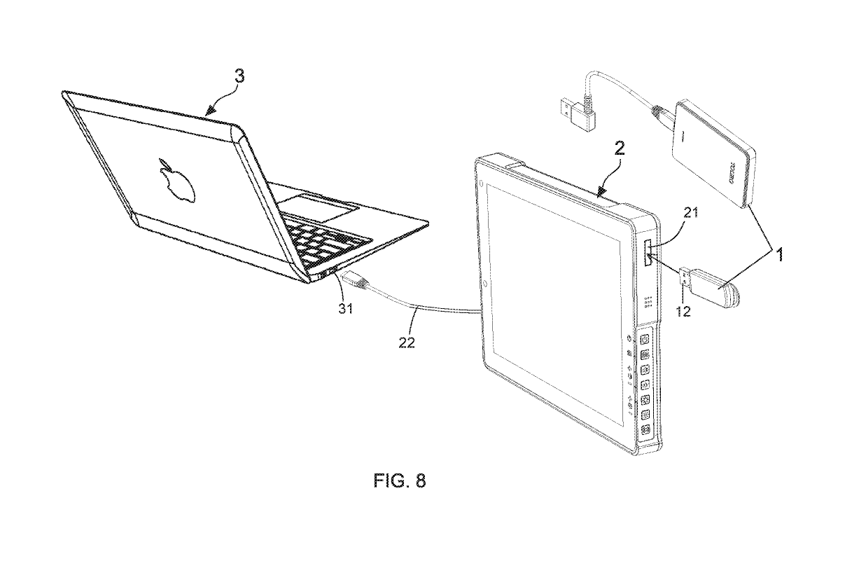

In summary, even if the host electronic device 3 does not installed with driver software of the digital photo frame (peripheral device 2), the host electronic device 3 still can control the digital photo frame (peripheral device 2) by using the text editor program and the image/video studio program installed in its operating system based on this novel peripheral device controlling method. Herein, the text editor program and/or the image and video studio program can be regarded as an application program of accessing device file, which is mainly used for accessing the contents of the device accessing file. Moreover, is not used for approaching a limitation in the practice of the storage device 1 even though FIG. 6 shows that the storage device 1 is a memory card. From a second stereo diagram of the storage device capable of controlling peripheral devices shown by FIG. 8, it can understand that the said storage device 1 can also be a flash drive, an external hard disk drive or a memory module integrated in the peripheral device 2. Moreover, according to FIG. 7 and FIG. 8, all the I/O interface 31, the first communication interface 21, the second communication interface 22, and the first communication unit 12 are an USB communication interface. However, they can also be a SATA interface, PATA interface, Lightning interface, or Ethernet interface. Of course, all the I/O interface 31, the first communication interface 21, the second communication interface 22, and the first communication unit 12 can also be a wireless communication interface, such as WiFi interface, Bluetooth interface, and wireless Ethernet interface.

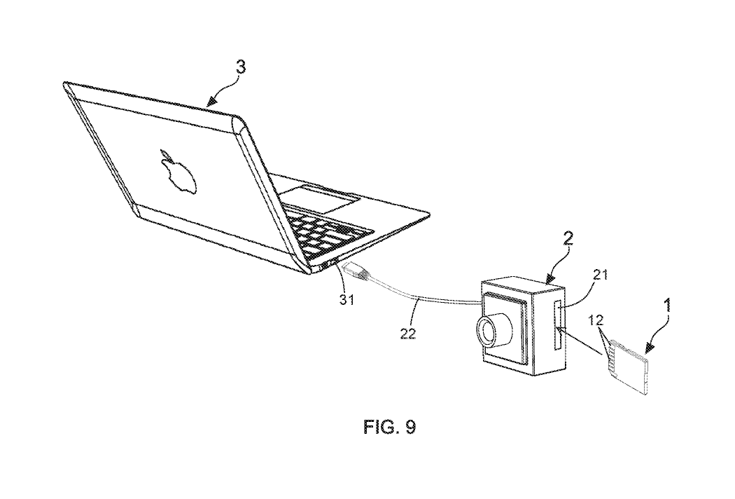

FIG. 9 shows a third stereo diagram of the storage device capable of controlling peripheral devices, wherein the peripheral device 2 is a lens device. As FIG. 7 and FIG. 9 show, after a communication channel is established between the I/O interface 31 of the host electronic device 3 and the second communication interface 22 of the peripheral device 2, the device accessing file of “camera_4K.bmp” or “camera_8M.bmp” can be found out from the storage device 1. Therefore, by using an image and video studio program installed in the operating system of the host electronic device 3, it is able to change or edit a plurality setting parameters of the lens device, such as white balance, exposure value (EV), exposure compensation (EC), color temperature (CT), and so on. Based on the changed setting parameters, microprocessor 20 immediately executes corresponding setting or adjusting to the lens device (peripheral device 2). On the other hand, by using the image and video studio program installed in the operating system of the host electronic device 3, the host electronic device 3 can easily access some raw image files such as “camera_4K.bmp” or “camera_8M.bmp” stored in the storage unit 14.

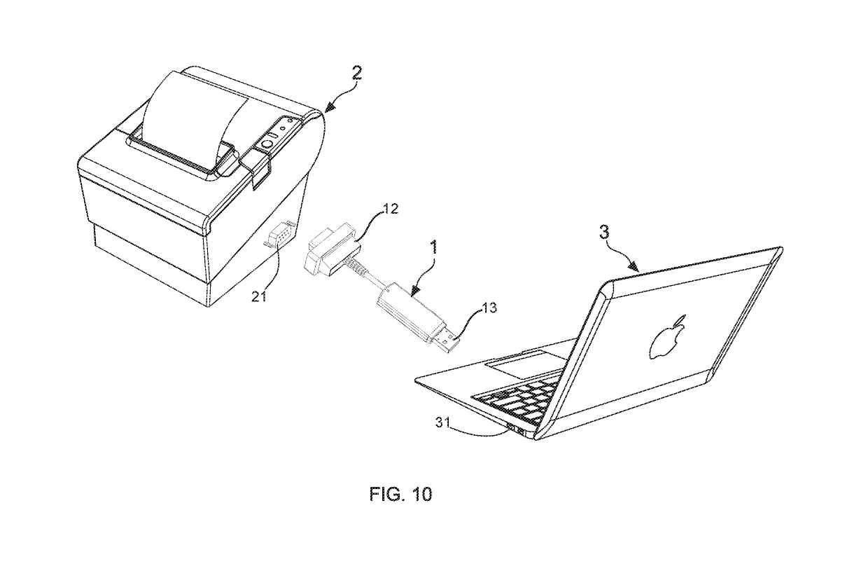

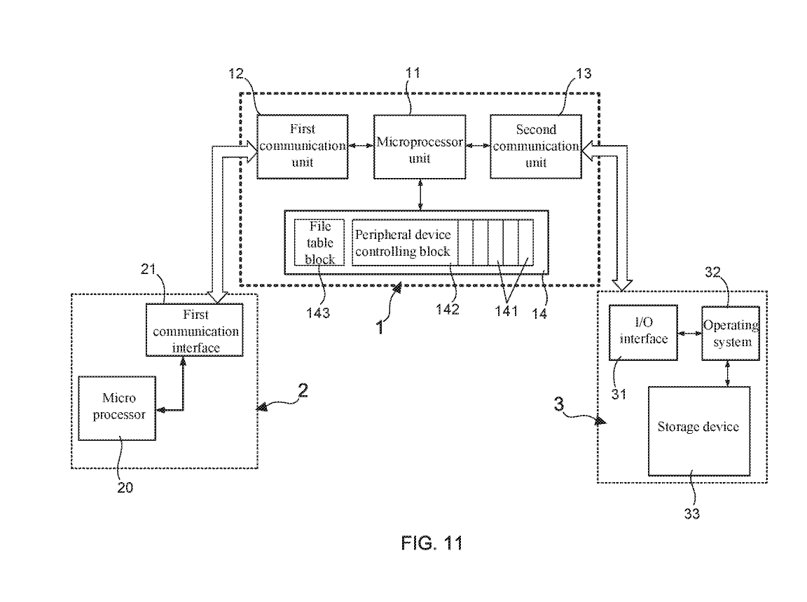

Furthermore, please refer to FIG. 10, which illustrates a stereo diagram of a second embodiment of the storage device capable of controlling peripheral devices according to the present invention. Moreover, FIG. 11 presents a framework view of the storage device capable of controlling peripheral devices. In second embodiment, the said storage device 1 is a flash drive having a USB communication interface and a serial port terminal, and the peripheral device 2 is a label printer having a serial port terminal. As FIG. 10 and FIG. 11 show, the storage device 1 comprises a microprocessor unit 11, a first communication unit 12 (i.e., the serial port terminal), a second communication unit 12 (USB interface), and a storage unit 14, wherein first communication unit 12 is coupled to the microprocessor unit 11 and used for connecting to a first communication interface 21 (i.e., the serial port terminal) of the peripheral device 2 (i.e., the label printer). On the other hand, the second communication unit 13 is also coupled to the microprocessor unit 11 (USB interface) and used for connecting to an I/O interface 31 (USB interface) of a host electronic device 3.

After a first communication channel is established between the first communication unit 12 of the storage device 1 and the first communication interface 21 of the peripheral device 2 as well as a second communication channel is established between an (USB) I/O interface 31 of the host electronic device 3 and the second communication unit 13 of the storage device 1, the device accessing file of “serial.io” can be easily found out from the storage device 1. Next, the storage block 141 storing with the device accessing file of “serial.io” would be set as a peripheral device controlling block 142 by an operating system 32 of the host electronic device 3 and its file system. Thus, by using an editor program (i.e., an application program of accessing device file) installed in the operating system 32 of the host electronic device 3, it is able to change or edit contents of the device accessing file of “serial.io”. Therefore, after the contents of the “serial.io” are changed, microprocessor 20 immediately drives the label printer (i.e., the peripheral device 2) executes corresponding actions; for example, printing a receipt.

In summary, even if the host electronic device 3 does not installed with driver software of the label printer, the host electronic device 3 still can control the label printer by using the editor program (i.e., the application program of accessing device file) installed in its operating system 32 based on this novel peripheral device controlling method. Therefore, through above descriptions, the peripheral device controlling method by using storage device and the storage device capable of controlling peripheral devices proposed by the present invention have been introduced completely and clearly; in summary, the present invention includes the advantages of:

(1) The present invention mainly provides a storage device 1 capable of controlling peripheral devices, which comprises a micro processing unit 11, a first communication unit 12 and a storage unit 14. Particularly, the storage unit 14 is separated into a plurality of storage blocks 141 and one file table block 143 based on a file system, and one of the storage blocks 141 storing with device accessing files is further set to be a peripheral device controlling block 142. After connecting the storage device 1 to a peripheral device 2 and a host electronic device 3, the host electronic device 3 can control the peripheral device 2 through changing contents of the device accessing files. Thus, for the peripheral device manufactures, it merely needs to develop driver software of this storage device 1 and an application program for accessing the device accessing file, but does not need to develop corresponding peripheral device driver softwares compatible with various host operating systems, such as Windows and iOS.

(2) On the other hand, even if the host electronic device 3 does not installed with driver software of the label printer, the host electronic device 3 still can control the label printer by using the editor program (i.e., the application program of accessing device file) installed in its operating system 32 based on this novel peripheral device controlling method.

The above description is made on embodiments of the present invention. However, the embodiments are not intended to limit scope of the present invention, and all equivalent implementations or alterations within the spirit of the present invention still fall within the scope of the present invention.

1. A peripheral device controlling method, comprising following steps:
(1) connecting a storage device to a peripheral device, wherein a storage unit of the storage device is separated into a plurality of storage blocks and one file table block based on a file system, and one of the plurality of storage blocks stored at least one device accessing file of the peripheral device; and wherein the peripheral device directly connects to a host electronic device or communicate with the host electronic device through the storage device;
(2) providing a device file accessing unit in the host electronic device;
(3) the device file accessing unit accessing at least one file table from the file table block, so as to find out the storage block storing with the device accessing file by looking up the file table;
(4) the device file accessing unit setting the storage blocks storing with the device accessing file as a peripheral device controlling block; and
(5) the host electronic device controlling the peripheral device executing actions by using the device file accessing unit to edit contents of the device accessing file stored in the peripheral device controlling block.

2. The peripheral device controlling method of claim 1, wherein the file system is selected from the group consisting of FAT, FAT8, FAT12, FAT16, FAT32, exFAT, ISO9660, UDF, NTFS, HFS, HFS+, ext2, ext3, and ext4.

3. The peripheral device controlling method of claim 1, wherein the host electronic device is selected from the group consisting of portable electronic device, server device, smart phone, tablet PC, smart watch, desk computer, laptop computer, and industrial computer.

4. The peripheral device controlling method of claim 1, wherein the storage device is selected from the group consisting of memory card, flash drive, and external hard disk drive.

5. The peripheral device controlling method of claim 1, wherein the operating system is selected from the group consisting of Windows, iOS, MAC OS X, Android, and Linux.

6. A storage device, being used to control a peripheral device in combination with a host electronic device; wherein a device file accessing unit is provided in the host electronic device, and the storage device comprising:
a microprocessor unit;
a communication unit, being coupled to the microprocessor unit and used for connecting to a first communication interface of the peripheral device; wherein the peripheral device connecting to the host electronic device by a second communication interface thereof; and
a storage unit, being separated into a plurality of storage blocks and one file table block storing with at least one file table based on a file system; wherein the device file accessing unit is configured to find out at least one device accessing file from the plurality of storage blocks by looking up the file table, so as to set the storage block storing with the device accessing file as a peripheral device controlling block;
wherein the host electronic device controls the peripheral device executing actions by using the device file accessing unit to edit contents of the device accessing file stored in the peripheral device controlling block.

7. The storage device of claim 6, wherein the file system is selected from the group consisting of FAT, FAT8, FAT12, FAT16, FAT32, exFAT, ISO9660, UDF, NTFS, HFS, HFS+, ext2, ext3, and ext4.

8. The storage device of claim 6, wherein the host electronic device is selected from the group consisting of portable electronic device, server device, smart phone, tablet PC, smart watch, desk computer, laptop computer, and industrial computer.

9. The storage device of claim 6, wherein the host electronic device is installed with an application program of accessing device file, used for accessing the contents of the device accessing file.

10. The storage device of claim 6, wherein the storage device is selected from the group consisting of memory card, flash drive, and external hard disk drive.

11.-12. (canceled)

13. A storage device, being used to control a peripheral device in combination with a host electronic device; wherein a device file accessing unit is provided in the host electronic device, and the storage device comprising:
a microprocessor unit;
a first communication unit, being coupled to the microprocessor unit and used for connecting to a communication interface of the peripheral device;
a second communication unit, being coupled to the microprocessor unit and used for connecting to an I/O interface of the host electronic device; and
a storage unit, being separated into a plurality of storage blocks and one file table block storing with at least one file table based on a file system; wherein the device file accessing unit is configured to find out at least one device accessing file from the plurality of storage blocks by looking up the file table, so as to set the storage block storing with the device accessing file as a peripheral device controlling block;
wherein the host electronic device controls the peripheral device executing actions by using the device file accessing unit to edit contents of the device accessing file stored in the peripheral device controlling block.

14. The storage device of claim 13, wherein the file system is selected from the group consisting of FAT, FAT8, FAT12, FAT16, FAT32, exFAT, ISO9660, UDF, NTFS, HFS, HFS+, ext2, ext3, and ext4.

15. The storage device of claim 13, wherein the host electronic device is selected from the group consisting of portable electronic device, server device, smart phone, tablet PC, smart watch, desk computer, laptop computer, and industrial computer.

16. The storage device of claim 13, wherein the host electronic device is installed with an application program of accessing device file, used for accessing the contents of the device accessing file.

17. The storage device of claim 13, wherein the storage device is selected from the group consisting of memory card, flash drive, and external hard disk drive.

18.-19. (canceled)
